(19) United States
(12) Patent Application Publication
(10) Pub. No.: US 2025/0249571 A1
(43) Pub. Date: Aug. 7, 2025

(54) INDUSTRIAL MUSCULAR STRENGTH ASSISTANCE ROBOT

(71) Applicant: INDUSTRY-ACADEMIC COOPERATION FOUNDATION, YONSEI UNIVERSITY, Seoul (KR)

(72) Inventors: Dong Jun SHIN, Seoul (KR); Dong Un LEE, Seoul (KR)

(21) Appl. No.: 18/982,621

(22) Filed: Dec. 16, 2024

(30) Foreign Application Priority Data
Feb. 2, 2024 (KR) 10-2024-0016627
Dec. 4, 2024 (KR) 10-2024-0178157

(51) Int. Cl. B25J 9/00

(52) U.S. Cl. CPC B25J 9/0006

(57) ABSTRACT

An embodiment provides an industrial muscle-strength assistive robot, including: a wearing part; a pair of arm muscle-strength assistive parts connected to the upper body wearing member so as to be adjacent to the shoulders of the user and movable along an upper part of the upper body wearing member; a wire part connecting the pair of arm wearing members and the pair of arm muscle-strength assistive parts; a fixing part coupled to the upper body wearing member so as to be positioned at a bottom part of the pair of arm muscle-strength assistive parts; an auxiliary muscle strength conversion part coupled to the upper body wearing member so as to be positioned at a bottom part of the fixing part and selectively assisting one of waist muscle strength and arm muscle strength of the user; and a string twist driving part coupled to the waist wearing member.

### CROSS-REFERENCE TO RELATED APPLICATION

This application claims priority to Korean Patent Application No. 10-2024-0016627, filed on Feb. 2, 2024, and Korean Patent Application No. 10-2024-0178157, filed on Dec. 4, 2024, the entirety of which is incorporated herein by reference for all purposes.

### BACKGROUND

The disclosure relates to an industrial muscle-strength assistive robot, and more specifically, to an industrial muscle-strength assistive robot that assists a user's waist muscle strength and arm muscle strength in two stages by using a string twist driving part and an auxiliary muscle strength conversion part.

The lumbar region of a person is where the muscle group (erector spinae) responsible for the greatest force is located. This is an essential element for large muscle strength due to large moment arm since people perform most of their work with their hands. Therefore, back injuries often occur when bending the waist to move heavy objects in industrial sites, agriculture, and fisheries, and in daily life.

Previously, muscle-strength assistive robots and exoskeletons have been developed to supplement insufficient muscle strength. The muscle strength required by a person can be sufficiently assisted, but high reduction ratio, high weight, high friction, and high cost electric actuators are used to generate large forces. In order to efficiently transmit the power of these actuators, a high-rigidity structure was also essential. The disadvantages of these assistance robots and exoskeletons are that they are not backdrivable be reversed, making them unsafe, and they are expensive, making them difficult for the general public to access. In addition, elderly people and people with disabilities who have relatively weaker muscle strength than the general public have difficulty supporting the weight of non-powered assistance robots and exoskeletons.

Various drive technologies have been studied to solve the shortcomings of existing muscle-strength assistive robots and exoskeletons. Among them, twisted string actuator technology is a flexible drive technology that uses light and inexpensive yarn, and can be used more safely than a motor in a machine device where humans and robots collaborate. In string twisted string actuator technology, the yarn acts as a gear that converts the rotational motion of the motor into translational motion. The length of the yarn is one of the important factors in determining the gear ratio, and the longer the yarn is, the higher the gear ratio is. By utilizing the characteristics of this string twist drive technology, this can be used as the role of the erector spinae, one of the longest muscles in the human body, to help robot users with their insufficient muscle strength at a relatively low cost.

Korean Patent No. 2091227 (assistant apparatus for lumbar motion) disclosed in relation thereto is an assisting device having two fixed bodies in the upper and lower body parts based on a lumbar support member and attached to both sides of the body, which may be driven in an idle state to maintain posture, and is configured so that an actuator built into the lumbar support member applies contraction/tension to the lumbar vertebrae according to the desired direction.

Korean Patent No. 1988078 (wearable apparatus for assisting muscular strength) has a driving unit in the backrest and uses a motor and wire driving method to drive a rotating body in the pelvic area, wherein the rotating body may drive a fixed body located in the thigh, and when driven, a force is applied to the thigh to assist muscle strength in the waist as a reaction force.

Korean Patent No. 2177307 (calibration device which combines strength training position) is a posture correction device also used for muscle strength exercise, which includes an exercise unit consisting of an exercise plate with compression and bending elasticity and an elastic unit installed in the back area between the shoulder blades, and additionally, a lumbar muscle exercise unit equipped to operate with a certain elasticity is installed in the lumbar area, so that muscle strength exercise of the back and lumbar muscles can be performed while correcting posture.

However, the conventional technology inevitably used high-rigidity, high-weight, and high-cost actuators to assist the large force required by a wearer. This inevitably increases the overall weight, cost, and volume of a robot system.

In addition, such an actuator cannot ensure backdrivability in case of malfunction, so the safety of a wearer is not guaranteed.

In addition, since the waist muscle-strength assistive robot is designed based on healthy ordinary people, there are many risks for relatively weak people such as the elderly, children, and the disabled to use it. In particular, in order to generate large force, a large support part/fixing part is required, which requires a high-rigidity material. Therefore, as the self-weight of the entire system increases, it is very difficult to attach and detach it without the help of others, and since the self-weight must be supported by the wearer's muscle strength when not in operation, there is a problem that it can cause injury.

Likewise, muscle-strength assistive robots and exoskeletons made of rigid materials must be adjusted to fit the individual wearer's body, and this approach has the disadvantage of necessitating parts replacements for size adjustments, which results in both poor versatility and wearability of wearable robots.

### SUMMARY

An aspect of the disclosure is to provide an industrial muscle-strength assistive robot, wherein an arm muscle-strength assistive part movable forward and backward based on a user's shoulder line is installed in a part located between the user's head and shoulder in a wearing part, a string twist driving part is installed in a part located at the user's waist in the wearing part, and an auxiliary muscle strength conversion part is installed in the center of the wearing part, and a pair of twist strings, which are fixed at both ends to a power member and the arm muscle-strength assistive part and inserted into the inside of the auxiliary muscle strength conversion part, are rotated in one direction by the power member, thereby primarily contracting between the auxiliary muscle strength conversion part and the string twist driving part to assist the user's waist muscle strength, and then secondarily contracting between a fixing part and the auxiliary muscle strength conversion part to assist the user's arm muscle strength.

The aspect of the disclosure is not limited to that mentioned above, and other aspects not mentioned will be clearly understood by those skilled in the art from the description below.

The disclosure provides an industrial muscle-strength assistive robot, including: a wearing part including an upper body wearing member worn on the upper body of a user, a waist wearing member coupled to a lower part of the upper body wearing member and surrounding the waist of the user, and a pair of arm wearing members respectively worn on both arms of the user; a pair of arm muscle-strength assistive parts connected to the upper body wearing member so as to be adjacent to the shoulders of the user and movable along an upper part of the upper body wearing member; a wire part connecting the pair of arm wearing members and the pair of arm muscle-strength assistive parts; a fixing part coupled to the upper body wearing member so as to be positioned at a lower part of the pair of arm muscle-strength assistive parts; an auxiliary muscle strength conversion part coupled to the upper body wearing member so as to be positioned at a lower part of the fixing part and selectively assisting one of waist muscle strength and arm muscle strength of the user; and a string twist driving part coupled to the waist wearing member, at least a part of which is inserted into the inside of the fixing part and the auxiliary muscle strength conversion part and then fixed to the arm muscle-strength assistive part and rotated in one or the other direction, wherein at least a part of the string twist driving part is contracted in the order of lower and upper to sequentially assist the user's waist muscle strength and arm muscle strength.

In an embodiment of the disclosure, the string twist driving part may include: a power housing coupled to the waist wearing member; a power member positioned inside the power housing and generating a rotational force; and a pair of twist strings, one end of which is fixed to the pair of arm muscle-strength assistive parts, inserted into the inside of the fixing part and the inside of the auxiliary muscle strength conversion part, and the other end of which is connected to the power member, wherein when the power member rotates the pair of twist strings in one direction, the pair of twist strings are first contracted while being twisted between the auxiliary muscle strength conversion part and the power housing to assist the user's waist muscle strength, and then are secondarily contracted while being twisted between the fixing part and the auxiliary muscle strength conversion part to assist the user's arm muscle strength.

In an embodiment of the disclosure, the auxiliary muscle strength conversion part may include: a housing coupled to the central part of the upper body wearing member; a bearing installed inside the housing; and a rotation plate rotatable with a lower part inserted into the inside of the bearing so that the pair of twist strings are inserted vertically, wherein the rotation plate maintains a non-rotating state until the twist string rotates in one direction by the power member and is twisted between the auxiliary muscle strength conversion part and the power housing and is first contracted, and then selectively converts the transmission power to assist the user's waist muscle strength and arm muscle strength respectively as rotating in one direction.

In an embodiment of the disclosure, the rotation plate may have a pair of rotation plate holes which are formed vertically and through which the pair of twist strings are inserted, and the pair of rotation plate holes may be arranged to be spaced apart from each other.

In an embodiment of the disclosure, the arm muscle-strength assistive part may include: a guide member coupled to the upper body wearing member so as to be adjacent to the shoulder of the user; a movement member connected to an upper part of the guide member and moving along the guide member; and a fixing member which is fixed to opposite sides of the movement member and protrudes upward, and to which the pair of wire parts and the pair of twist strings are fixed, wherein the movement member assists the arm muscle strength of the user by moving backward based on the shoulder line of the user when the pair of twist strings are twisted between the fixing part and the auxiliary muscle strength conversion part and contracted secondarily.

In an embodiment of the disclosure, formed at the fixing part may be a pair of fixing part holes that are inclined at a predetermined angle so as to be symmetrical to each other based on the central axis that divides the fixing part into left and right and meet at one point, and the pair of twist strings may be inserted into the pair of fixing part holes to form a “Y” shape.

In an embodiment of the disclosure, the wearing part may further include a hip wearing member coupled to a lower part of the upper body wearing member to wrap around the user's hip; and the hip wearing member may prevent the string twist driving part from rising as at least a part of the string twist driving part is contracted.

In an embodiment of the disclosure, the industrial muscle-strength assistive robot may further include: a sensor part for measuring the inertia of the user's waist, arms, and legs in real time to measure the user's waist bending angle, the user's arm bending angle, and the user's leg bending angle; and a control part for comparing the user's waist bending angle, the user's arm bending angle, and the user's leg bending angle transmitted from the sensor part with a preset waist bending angle, a preset arm bending angle, and a preset leg bending angle, and then feedback-controlling the string twist driving part so that the user operates at the preset waist bending angle, the preset arm bending angle, and the preset leg bending angle.

In an embodiment of the disclosure, the sensor part may include: a reference IMU sensor attached to the waist wearing member so as to be positioned on the waist of the user and measuring a reference inertial value; a first IMU sensor attached to the upper body wearing member so as to be positioned on the back of the user and measuring a back inertial value; a second IMU sensor attached to one of the pair of arm wearing members and measuring a first arm inertial value; a third IMU sensor attached to the other of the pair of arm wearing members and measuring a second arm inertial value; a fourth IMU sensor attached to one of the pair of thighs of the user and measuring a first leg inertial value; and a fifth IMU sensor attached to the other of the pair of thighs of the user and measuring a second leg inertial value, wherein the control unit compares the reference inertial value with the back inertial value to derive a waist bending angle of the user, and compares the reference inertial value with the first and second arm inertial values to derive an arm bending angle of the user, and compares the reference inertial value with the first and second leg inertial values to derive a leg bending angle of the user.

As effects of the disclosure, an arm muscle-strength assistive part movable forward and backward based on a user's shoulder line is installed in a part located between the user's head and shoulder in a wearing part, a string twist driving part is installed in a part located at the user's waist in the wearing part, and an auxiliary muscle strength conversion part is installed in the center of the wearing part, and a pair of twist strings, which are fixed at both ends to a power member and the arm muscle-strength assistive part and inserted into the inside of the auxiliary muscle strength conversion part, are rotated in one direction by the power member, thereby primarily contracting between the auxiliary muscle strength conversion part and the string twist driving part to assist the user's waist muscle strength, and then secondarily contracting between a fixing part and the auxiliary muscle strength conversion part to assist the user's arm muscle strength.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a rear view from one direction showing an industrial muscle-strength assistive robot according to an embodiment of the disclosure;

FIG. 2 is a conceptual view showing the location of a sensor part equipped in an industrial muscle-strength assistive robot according to an embodiment of the disclosure;

FIG. 3 is a side view from one direction showing an industrial muscle-strength assistive robot according to an embodiment of the disclosure;

FIGS. 4A, 4B, and 4C are each a conceptual view showing an operation process of an industrial muscle-strength assistive robot according to an embodiment of the disclosure;

FIGS. 5A and 5B are each a conceptual view showing a twist string actuator distance (TSA Distance), a twist string actuator force (TSA Force), a propagation angle, and a propagation force when a pair of twist strings equipped in an industrial muscle-strength assistive robot according to an embodiment of the disclosure are twisted and contracted;

FIGS. 6A and 6B are view showing a mechanism for assisting a user's waist muscle strength and arm muscle strength by an industrial muscle-strength assistive robot according to an embodiment of the disclosure;

FIGS. 7A and 7B are each an actual photograph showing a motion for assisting a user's waist muscle strength by an industrial muscle-strength assistive robot according to an embodiment of the disclosure;

FIGS. 8A and 8B are each an actual photograph showing a motion for assisting a user's arm muscle strength by an industrial muscle-strength assistive robot according to an embodiment of the disclosure; and

FIGS. 9A and 9B are each an actual photograph showing a separate motion for sequentially assisting a user's waist muscle strength and arm muscle strength by an industrial muscle-strength assistive robot according to an embodiment of the disclosure.

### DETAILED DESCRIPTION

Hereinafter, the disclosure will be described with reference to the accompanying drawings. However, the disclosure may be implemented in various different forms, and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not mean that other components are excluded unless otherwise specifically stated, but that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

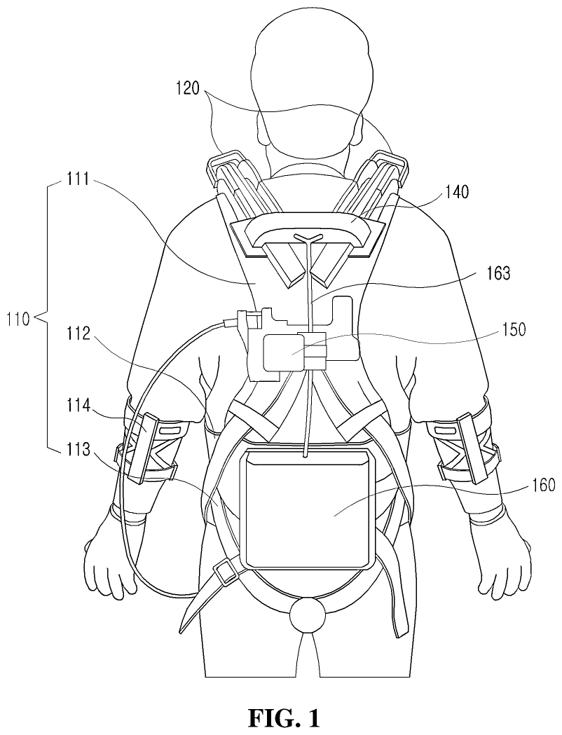

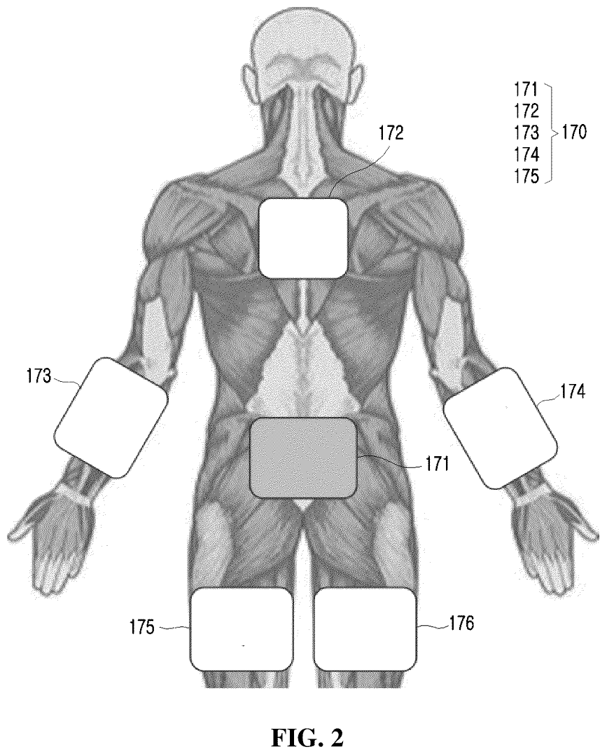

FIG. 1 is a rear view from one direction showing an industrial muscle-strength assistive robot according to an embodiment of the disclosure. FIG. 2 is a conceptual view showing the location of a sensor part equipped in an industrial muscle-strength assistive robot according to an embodiment of the disclosure.

Referring to FIGS. 1 and 2, an industrial muscle-strength assistive robot 100 according to an embodiment of the disclosure includes a wearing part 110, an arm muscle-strength assistive part 120, a wire part 130, a fixing part 140, an auxiliary muscle strength conversion part 150, a string twist driving part 160, a sensor part 170, and a control part.

The wearing part 110 includes an upper body wearing member 111, a waist wearing member 112, a hip wearing member 113, and an arm wearing member 114.

The upper body wearing member 111 is fastened by a buckle and worn on a user's upper body. For example, the upper body wearing member 111 may be any one of an industrial safety harness, an X-band, and a five-point belt.

Specifically, the upper body wearing member 111 may be formed in an “X” shape as shown in FIG. 1 but is not limited thereto and may be formed in a Q H Q shape or a D D shape, and other wearable suits may also be applied.

Specifically, the upper part of the upper body wearing member 111 is branched upwardly and left and right from the center of the upper body wearing member 111 and is worn to wrap around the user's head and shoulders.

In addition, the lower part of the upper body wearing member 111 is branched downwardly and left and right from the center of the upper body wearing member 111.

In addition, the auxiliary muscle strength conversion part 150 is coupled to the center of the upper body wearing member 111.

The waist wearing member 112 is coupled to the lower part of the upper body wearing member 111 and is formed to wrap around the user's waist.

The waist wearing member 112 is coupled with the string twist driving part 160.

The hip wearing member 113 is coupled to the lower part of the upper body wearing member 111 to wrap around the user's hips.

Specifically, the hip wearing member 113 may be coupled to the waist wearing member 112 by passing between the user's legs from both sides of the user's waist.

The hip wearing member 113 prevents the string twist driving part 160 from rising as at least a part of the string twist driving part 160 is contracted.

The arm wearing member 114 is worn on each of the user's arms and is configured as a pair.

For example, a pair of arm wearing members 114 may be worn to wrap around the flexor muscles of the user's arms but is not limited thereto, and it is sufficient if they are worn only under the user's heels.

However, a pair of arm wearing members 114 may assist the user's arm muscle strength with less force the further they are worn from the elbow.

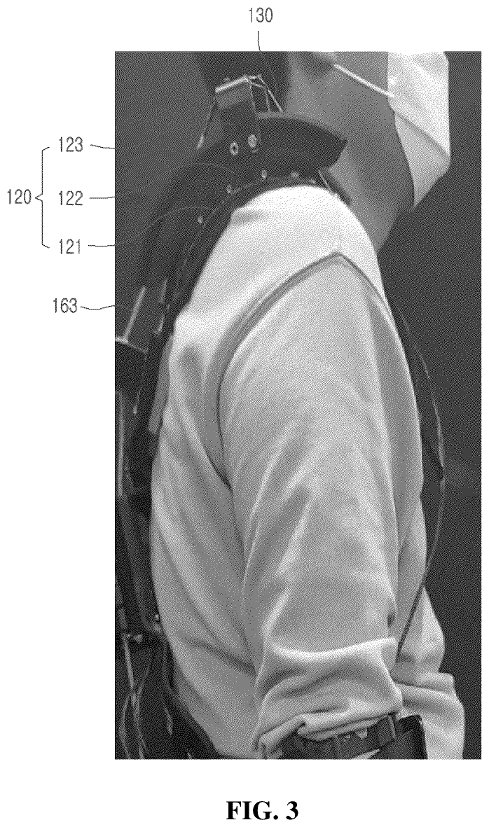

FIG. 3 is a side view from one direction showing an industrial muscle-strength assistive robot according to an embodiment of the disclosure.

Referring to FIG. 1, the arm muscle-strength assistive part 120 is connected to the upper body wearing member 111 so as to be adjacent to the user's shoulder and is movable along the upper part of the upper body wearing member 111, and is configured as a pair.

Referring to FIG. 3, the arm muscle-strength assistive part 120 includes a guide member 121, a movement member 122, and a fixing member 123.

The guide member 121 is coupled to the upper body wearing member 111 so as to be adjacent to the user's shoulder.

Specifically, the guide member 121 may be worn so as to pass between the user's head and shoulder.

Accordingly, it is preferable that the guide member 121 has an arch shape so as to be closely fitted between the user's head and shoulder.

The movement member 122 is connected to the upper part of the guide member 121 and moves along the guide member 121.

The movement member 122 therefor may have an arch shape corresponding to the guide member 121.

The movement member 122 described above may assist the user's arm muscle strength by moving backward based on the user's shoulder line when a pair of twist strings 163 are twisted between the fixing part 140 and the auxiliary muscle strength conversion part 150 and contracted secondarily.

Specifically, the movement member 122 is moved backwards based on the shoulder line when a pair of twist strings 163 are twisted between the fixing part 140 and the auxiliary muscle strength conversion part 150 and contracted secondarily, and accordingly, the wire part 130 fixed to the fixing member 123 is pulled, thereby pulling the arm wearing member 114 connected to the wire part 130, thereby pulling the user's arm.

The above-mentioned guide member 121 and movement member 122 may have a structure similar to a linear motor.

Referring to FIG. 3, the fixing member 123 is fixed to both sides of the movement member 122 and protrudes upward, and a pair of wire parts 130 and a pair of twist strings 163 are fixed.

The wire part 130 connects a pair of arm wearing members 114 and a pair of arm muscle-strength assistive parts 120, and is configured as a pair.

Specifically, one wire part 130 of the pair of wire parts 130 connects the fixing member 123 provided on one arm muscle-strength assistive part 120 of the pair of arm muscle-strength assistive parts 120 and one arm wearing member 114 of the pair of arm wearing members 114.

In addition, the other wire part 130 of the pair of wire parts 130 connects the fixing member 123 provided on the other arm muscle-strength assistive part 120 of the pair of arm muscle-strength assistive parts 120 and the other arm wearing member 114 of the pair of arm wearing members 114.

The above-mentioned pair of wire parts 130 assist the user's arm muscle strength by pulling the pair of arm wearing members 114 when the pair of twist strings 163 are secondarily contracted while being twisted between the fixing part 140 and the auxiliary muscle strength conversion part 150.

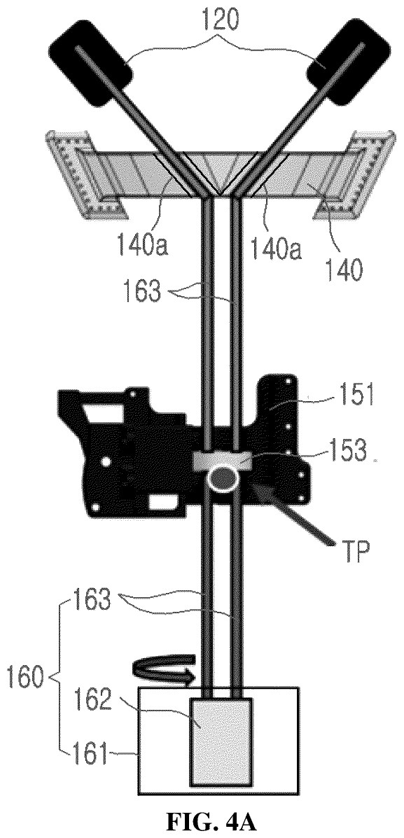

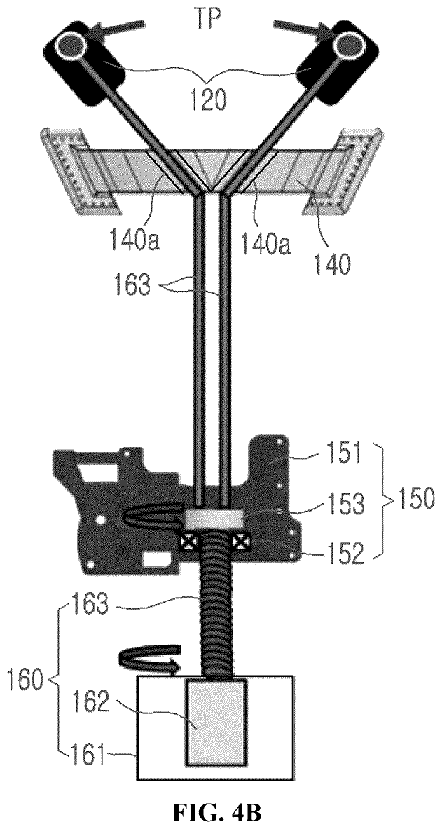

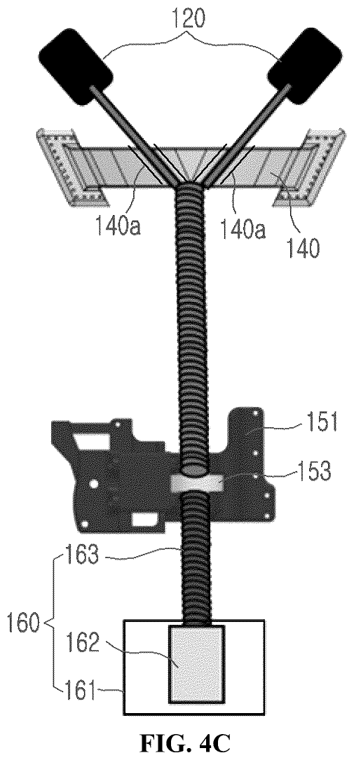

FIGS. 4A, 4B, and 4C are each a conceptual view showing an operation process of an industrial muscle-strength assistive robot according to an embodiment of the disclosure.

The fixing part 140 is coupled to the upper body wearing member 111 so as to be positioned below a pair of arm muscle-strength assistive parts 120.

Specifically, one side of the fixing part 140 is coupled to a part branched to one side of the upper part of the upper body wearing member 111, and the other side of the fixing part 140 is coupled to a part branched to the other side of the upper part of the upper body wearing member 111, and the central part of the fixing part 140 is formed to be spaced apart from the upper body wearing member 111 by a predetermined distance.

In addition, referring to FIG. 1 and FIGS. 4A, 4B, and 4C, a pair of fixing part holes 140a are formed in the fixing part 140 at a predetermined angle so as to be symmetrical to each other based on a central axis that divides the fixing part 140 into left and right, and to meet at a point (the lower part of the fixing part in FIGS. 4A, 4B, and 4C).

That is, the pair of fixing part holes 140a are formed to have a “V” shape.

A pair of twist strings 163 fixed to a pair of arm muscle-strength assistive parts 120 are inserted into the above-mentioned pair of fixing part holes 140a to guide the pair of twist strings 163.

Referring to FIG. 1, the auxiliary muscle strength conversion part 150 is coupled to the upper body wearing member 111 so as to be positioned below the fixing part 140 and selectively converts the transmission power to selectively assist either the user's waist muscle strength or arm muscle strength.

Referring to FIGS. 4A, 4B, and 4C, the auxiliary muscle strength conversion part 150 includes a housing 151, a bearing 152, and a rotation plate 153.

Referring to FIG. 4A, the housing 151 is coupled to the center part of the upper body wearing member 111.

Referring to FIG. 4B, the bearing 152 is installed inside the housing.

The bearing 152 supports the load of the rotation plate 153 and allows the rotation plate 153 to rotate smoothly.

The rotation plate 153 is rotated by having its lower part inserted into the inside of the bearing 152 so that a pair of twist strings 163 may be inserted in the upper and lower directions.

In addition, a pair of rotation plate holes (not shown) into which a pair of twist strings 163 are inserted are formed in the upper and lower directions through the rotation plate 153.

At this time, the pair of rotation plate holes are arranged to be spaced apart from each other.

The rotation plate 153 described above is configured such that the twist string 163 is rotated in one direction by the power member 162 as shown in FIG. 4A, and then, as shown in FIG. 4B, is twisted between the auxiliary muscle strength conversion part 150 and the power housing 161 and is maintained in a non-rotating state until it is first contracted, and then, as it rotates in one direction, to selectively convert the transmission power (waist muscle strength transmission power generated from the twist string 163 shown in red in FIG. 4C, and the arm muscle strength transmission power generated from the twist string 163 shown in green) to assist the user's waist muscle strength and arm muscle strength, respectively, as shown in FIG. 4C.

The string twist driving part 160 is coupled to the waist wearing member 112, and at least a part thereof is inserted into the inside of the fixing part 140 and the auxiliary muscle strength conversion part 150, and then fixed to the arm muscle-strength assistive part 120 to rotate in one direction or the other direction.

Here, at least a part of the string twist driving part 160 is a twist string 163, and the lower and upper parts of the twist string 163 are sequentially contracted to sequentially assist the user's waist muscle strength and arm muscle strength.

The string twist driving part 160 therefor includes a power housing 161, a power member 162, and a twist string 163.

The power housing 161 is coupled to the waist wearing member 112.

In addition, the power housing 161 is as shown in FIGS. 4A, 4B, and 4C, an internal space is formed to accommodate a power member 162.

The power member 162 is located inside the power housing 161 and generates a rotational force.

The power member 162 therefor may be, for example, an actuator or a motor, but is not limited thereto.

In addition, a pair of twist strings 163 are fixed to the upper part of the power member 162 so as to be spaced apart from each other by a predetermined distance.

When power is applied to the power member 162, the power member 162 generates a rotational force to rotate the pair of twist strings 163 in one direction or the other direction.

The twist string 163 is configured as a pair, with one end fixed to a pair of arm muscle-strength assistive parts 120, inserted into the inside of the fixing part 140 and the inside of the auxiliary muscle strength conversion part 150, and the other end connected to the power member 162.

Specifically, referring to FIG. 2, one end of the pair of twist strings 163 is fixed to a pair of fixing members 123, and accordingly, the part of the pair of fixing members 123 to which one end of the twist string 163 is fixed becomes a transmission point (TP) as shown in FIG. 4B.

In addition, referring to FIG. 4A, the other end of the pair of twist strings 163 is fixed to the upper part of the power member 162.

In addition, a pair of twist strings 162 each fixed to a pair of fixing members 123 are each inserted into a pair of fixing part holes 140a and the inside of the rotation plate 153. Accordingly, the lower part of the rotation plate 153 becomes the transmission point (TP) as shown in FIG. 4A.

The above-described pair of twist strings 163 are inserted into a pair of fixing part holes 140a formed in the fixing part 140 as shown in FIGS. 4A, 4B, and 4C to form a “Y” shape.

As shown in FIG. 4A, when the power member 162 rotates a pair of twist strings 163 in one direction, as shown in FIG. C, the pair of twist strings 163 are first contracted while being twisted between the auxiliary muscle strength conversion part 150 and the power housing 161 to assist the user's waist muscle strength, and then, as shown in FIG. 4C, they are secondarily contracted while being twisted between the fixing part 140 and the auxiliary muscle strength conversion part 150 to assist the user's arm muscle strength.

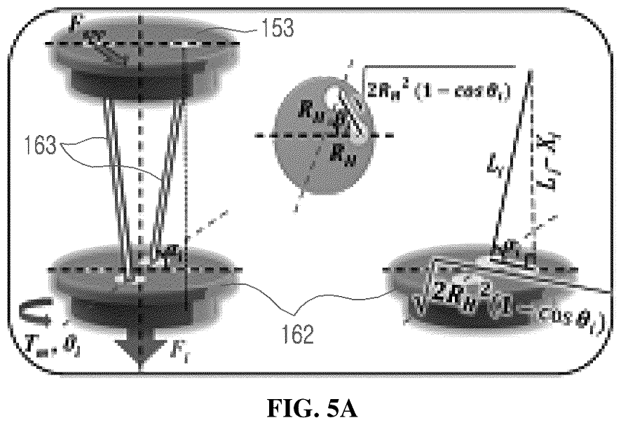

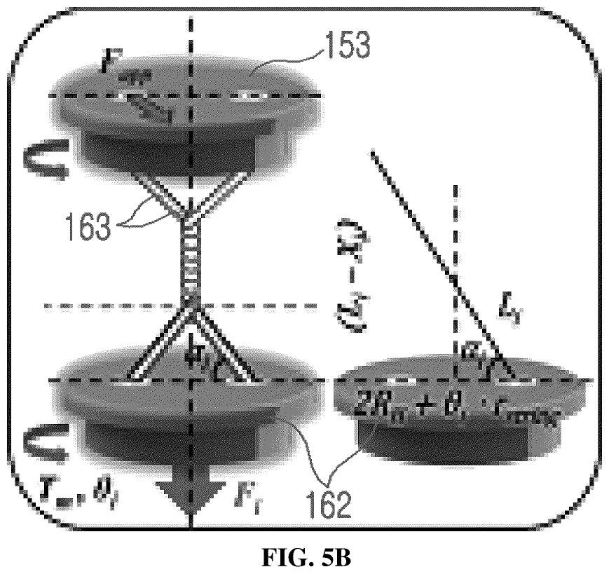

FIGS. 5A and 5B are each a conceptual view showing a twist string actuator distance (TSA Distance), a twist string actuator force (TSA Force), a propagation angle, and a propagation force when a pair of twist strings equipped in an industrial muscle-strength assistive robot according to an embodiment of the disclosure are twisted and contracted.

Referring to FIGS. 5A and 5B, the twist string actuator distance (Xᵢ) is defined by [Equation 1] below.

$${X}_{i} = {L}_{i} - \sqrt{{L}_{i}^{2} - {( 2 {R}_{H} + {θ}_{i} \cdot {r}_{string} )}^{2}} \qquad [ Equation 1 ]$$

(Here, Xᵢ=twist string actuator distance (TSA Displacement), Lᵢ=initial twist string length (Initial String Length), r_{string}=twist string radius (String Radius), θᵢ=motor rotation angle (Motor Revolution), R_{H}=distance between a pair of twist strings (Distance Between Strings)) Next, referring to FIGS. 5A and 5B, the twist string actuator force (Fᵢ) is defined by [Equation 2] below.

$${F}_{i} = GR \cdot {η}_{m} \cdot {T}_{m} \cdot {η}_{TSA} \frac{\sqrt{{L}_{i}^{2} - {( 2 {R}_{H} + {θ}_{i} \cdot {r}_{string} )}^{2}}}{{r}_{string} \cdot ( 2 {R}_{H} + {θ}_{i} \cdot {r}_{string} )} \qquad [ Equation 2 ]$$

(Here, Fᵢ=twist string actuator force (TSA Force), Lᵢ=initial twist string length (Initial String Length), r_{string}=twist string radius (String Radius), θᵢ=motor rotation angle (Motor Revolution), R_{H}=distance between a pair of twist strings (Distance Between Strings), GR=Gear Reduction Ratio, ηₘ=Motor Gear Reduction Efficiency, Tₘ=Max. Continuous Motor Torque, TSA=twist string actuator, η_{TSA}=twist string actuator transmission efficiency (TSA Transmission Efficiency))

Next, referring to FIGS. 5A and 5B, the propagation angle (αᵢ) is defined by [Equation 3] below.

$${α}_{i} = \{ \begin{matrix}{tan}^{- 1} ( \frac{{L}_{i} - {X}_{i}}{\sqrt{2 {R}_{H}^{2} ( 1 - cos {θ}_{i} )}} ) & ( {θ}_{i} < π ) \\ {tan}^{- 1} ( \frac{{L}_{i} - {X}_{i}}{2 {R}_{H} + {r}_{string} \cdot {θ}_{i}} ) & ( {θ}_{i} \geq π )\end{matrix} \qquad [ Equation 3 ]$$

(Here, αᵢ=Propagation Angle, Lᵢ=initial twist string length (Initial String Length), Xᵢ=twist string actuator distance (TSA Displacement), R_{H}=distance between a pair of twist strings (Distance Between Strings), r_{string}=twist string radius (String Radius), θᵢ=motor rotation angle (Motor Revolution))

Next, referring to FIGS. 5A and 5B, the propagation power (F_{app,i}) is defined by [Equation 4] below.

$${F}_{app , i} = Fi \cdot cos {α}_{i} \qquad [ Equation 4 ]$$

(Here, F_{app,i}=Propagation Force, Fᵢ=twist string actuator force (TSA Force), αᵢ=Propagation Angle)

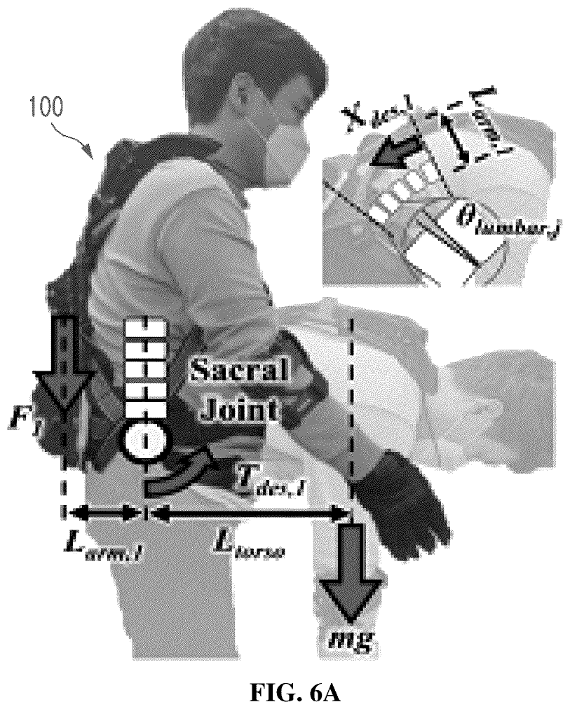

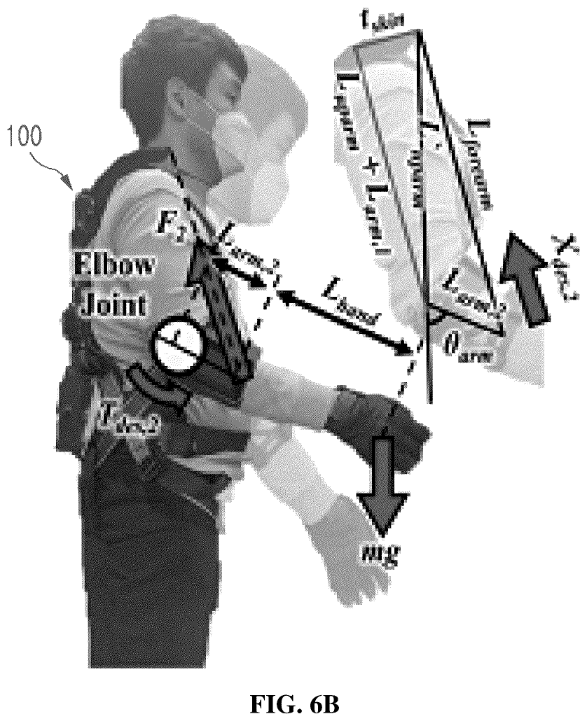

FIGS. 6A and 6B are view showing a mechanism for assisting a user's waist muscle strength and arm muscle strength by an industrial muscle-strength assistive robot according to an embodiment of the disclosure.

An industrial muscle-strength assistive robot 100 according to an embodiment of the disclosure primarily assists the user's waist muscle strength as shown in FIG. 6A, and secondarily assists the user's arm muscle strength as shown in FIG. 6B.

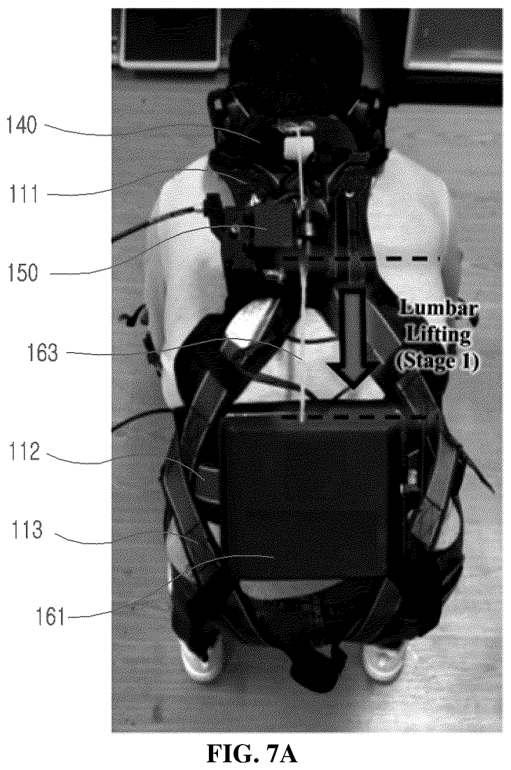

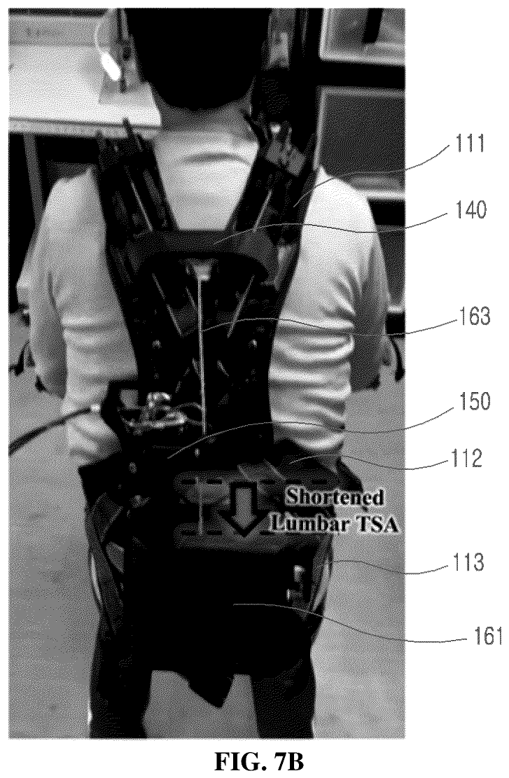

FIGS. 7A and 7B are each an actual photograph showing a motion for assisting a user's waist muscle strength by an industrial muscle-strength assistive robot according to an embodiment of the disclosure.

More specifically, as shown in FIG. 7A, when a user squats while wearing an industrial muscle-strength assistive robot 100 according to an embodiment of the disclosure, when the power member 162 rotates a pair of twist strings 163 in one direction, a pair of twist strings 163 located between the auxiliary muscle strength conversion part 150 and the power housing 161 among the pair of twist strings 163 twists and contracts primarily, thereby assisting the user with waist muscle strength, thereby causing the user to stand up, as shown in FIG. 7B.

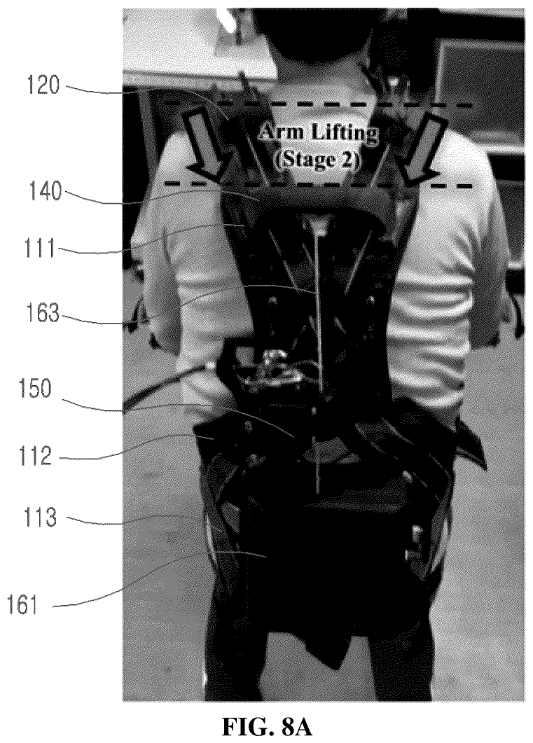

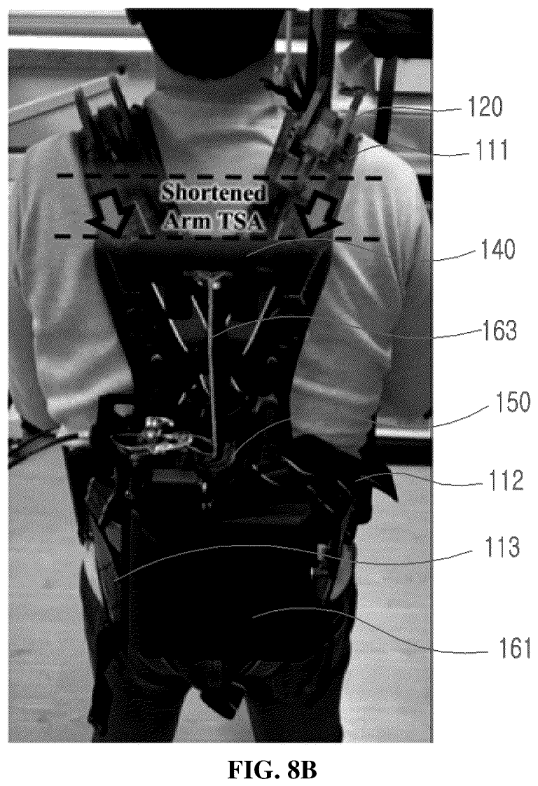

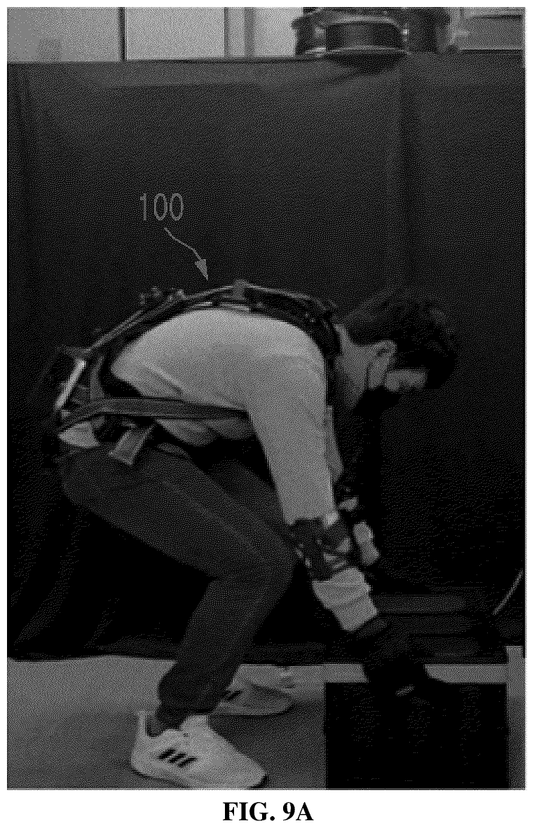

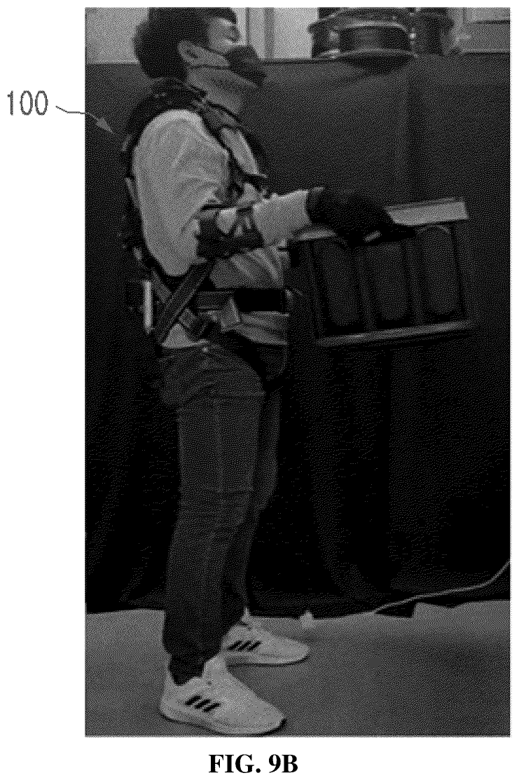

FIGS. 8A and 8B are each an actual photograph showing a motion for assisting a user's arm muscle strength by an industrial muscle-strength assistive robot according to an embodiment of the disclosure. FIGS. 9A and 9B are each an actual photograph showing a separate motion for sequentially assisting a user's waist muscle strength and arm muscle strength by an industrial muscle-strength assistive robot according to an embodiment of the disclosure.

Next, as shown in FIG. 8A and FIG. 9A, when the first contraction is completed while the user wears the industrial muscle-strength assistive robot 100 according to an embodiment of the disclosure, the rotation plate 153 also rotates together with a pair of twist strings 163, and as a pair of twist strings 163 located between the fixing part 140 and the auxiliary muscle strength conversion part 150 among the pair of twist strings 163 are twisted and contracted secondarily, assists the arm muscle strength of the user as shown in FIG. 8B and FIG. 9B.

The sensor part 170 measures the inertia of the user's waist, arms, and legs to measure the user's waist bending angle, the user's arm bending angle, and the user's leg bending angle in real time.

The sensor part 170 therefor includes a reference IMU sensor 171, a first IMU sensor 172, a second IMU sensor 173, a third IMU sensor 174, a fourth IMU sensor 175, and a fifth IMU sensor 176 as shown in FIG. 2.

The reference IMU sensor 171 is attached to a waist wearing member 112 so as to be positioned on the user's waist and measures a reference inertial value.

The first IMU sensor 172 is attached to an upper body wearing member 111 so as to be positioned on the user's back and measures a back inertial value.

The second IMU sensor 173 is attached to one of the pair of arm wearing members 112 and measures the first arm inertial value.

The third IMU sensor 174 is attached to the other of the pair of arm wearing members 112 and measures the second arm inertial value.

The fourth IMU sensor 175 is attached to one of the pair of thighs of the user and measures the first leg inertial value.

The fifth IMU sensor 176 is attached to the other of the pair of thighs of the user and measures the second leg inertial value.

The control part compares the user's waist bending angle, the user's arm bending angle, and the user's leg bending angle transmitted from the sensor part 170 with a preset waist bending angle, a preset arm bending angle, and a preset leg bending angle, and then feedback-controls the string twist driving part 160 so that the user operates at the preset waist bending angle, preset arm bending angle, and preset leg bending angle.

Specifically, the control part derives the user's waist bending angle by comparing the reference inertial value with the back inertial value, derives the user's arm bending angle by comparing the reference inertial value with the first and second arm inertial values, and derives the user's leg bending angle by comparing the reference inertial value with the first and second leg inertial values.

According to the above, the disclosure utilizes the characteristics of the string twist driving technology to perform the role of the erector spinae, which is one of the longest muscles in the human body, and thus can assist the insufficient muscle strength of a user wearing a robot at a relatively low cost, and can also be used to assist muscle strength of the biceps, thigh muscles, etc. in addition to the erector spinae.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

### EXPLANATION OF REFERENCE NUMERALS

100: industrial muscle-strength assistive robot
110: wearing part
111: upper body wearing member
112: waist wearing member
113: hip wearing member
114: arm wearing member
120: arm muscle-strength assistive part
121: guide member
122: movement member
123: fixing member
130: wire part
140: fixing part
140a: fixing part hole
150: auxiliary muscle strength conversion part
151: housing
152: bearing
153: rotation plate
160: string twist driving part
161: power housing
162: power member
163: twist string
170: sensor part
171: reference IMU sensor
172: first IMU sensor
173: second IMU sensor
174: third IMU sensor
175: fourth IMU sensor
176: fifth IMU sensor

1. An industrial muscle-strength assistive robot, comprising:
a wearing part comprising an upper body wearing member disposed on an upper body of a user, a waist wearing member coupled to a bottom part of the upper body wearing member and surrounding a waist of the user, and a pair of arm wearing members respectively disposed on both arms of the user;
a pair of arm muscle-strength assistive parts connected to the upper body wearing member so as to be adjacent to shoulders of the user and movable along a top part of the upper body wearing member;
a wire part connecting the pair of arm wearing members and the pair of arm muscle-strength assistive parts;
a fixing part coupled to the upper body wearing member so as to be positioned at a bottom part of the pair of arm muscle-strength assistive parts;
an auxiliary muscle strength conversion part coupled to the upper body wearing member so as to be positioned at a bottom part of the fixing part and configured to selectively assist one of waist muscle strength and arm muscle strength of the user; and
a string twist driving part coupled to the waist wearing member, wherein at least a part of the string twist driving part is inserted into both of inside of the fixing part and the auxiliary muscle strength conversion part and then fixed to the pair of the arm muscle-strength assistive parts and rotated in at least one direction, and
wherein the at least the part of the string twist driving part is configured to be contracted in an order from a bottom to a top of the string twist driving part to sequentially assist waist muscle strength and arm muscle strength of the user.

2. The industrial muscle-strength assistive robot of claim 1, wherein
the string twist driving part comprises:
a power housing coupled to the waist wearing member;
a power member positioned inside the power housing and configured to generate a rotational force; and
a pair of twist strings being inserted into the both of inside the fixing part and the auxiliary muscle strength conversion part, with one end fixed to the pair of arm muscle-strength assistive parts and another end connected to the power member,
wherein when the power member rotates the pair of twist strings in the at least one direction, the pair of twist strings are first contracted while being twisted between the auxiliary muscle strength conversion part and the power housing to assist the waist muscle strength of the user, and then are secondarily contracted while being twisted between the fixing part and the auxiliary muscle strength conversion part to assist the arm muscle strength of the user.

3. The industrial muscle-strength assistive robot of claim 2, wherein
the auxiliary muscle strength conversion part comprises:
a housing coupled to a center of the upper body wearing member;
a bearing installed inside the housing; and
a rotation plate being rotatable with a bottom part of the rotation plate inserted into the bearing to allow the pair of twist strings to be inserted vertically,
wherein the rotation plate maintains a non-rotating state until the pair of twist string rotate in the at least one direction by the power member and are twisted between the auxiliary muscle strength conversion part and the power housing to be first contracted, and then selectively converts a transmission power to assist the waist muscle strength and arm muscle strength of the user respectively as rotating in the at least one direction.

4. The industrial muscle-strength assistive robot of claim 3, wherein
the rotation plate has a pair of rotation plate holes defined vertically where the pair of twist strings are inserted, and
the pair of rotation plate holes are arranged to be spaced apart from each other.

5. The industrial muscle-strength assistive robot of claim 2, wherein
each of the pair of the arm muscle-strength assistive parts comprises:
a guide member coupled to the upper body wearing member so as to be adjacent to the shoulders of the user;
a movement member connected to a top part of the guide member and configured to move along the guide member; and
a fixing member which is fixed to two opposite sides of the movement member and protruding upward, and configured to fix a pair of wire parts and the pair of twist strings,
wherein the movement member assists the arm muscle strength of the user by moving backward based on a shoulder line of the user when the pair of twist strings are twisted between the fixing part and the auxiliary muscle strength conversion part and contracted secondarily.

6. The industrial muscle-strength assistive robot of claim 1, wherein
the fixing part includes a pair of fixing part holes that are symmetrically inclined at a predetermined angle to a central axis dividing the fixing part left and right, and meet at one point, and
the pair of twist strings are inserted into the pair of fixing part holes, resulting in a “Y” shape.

7. The industrial muscle-strength assistive robot of claim 1, wherein
the wearing part further comprises a hip wearing member coupled to the bottom part of the upper body wearing member to wrap around a hip of the user; and
the hip wearing member configured to prevents the string twist driving part from rising as at least a part of the string twist driving part is contracted.

8. The industrial muscle-strength assistive robot of claim 1, further comprising:
a sensor part configured to measure an inertia of the waist, arms, and legs of the user in real time to measure a waist bending angle, an arm bending angle, and a leg bending angle of the user; and
a control part configured to compare the waist bending angle, the arm bending angle, and the leg bending angle transmitted from the sensor part with a preset waist bending angle, a preset arm bending angle, and a preset leg bending angle, and then feedback-control the string twist driving part so that the user operates at the preset waist bending angle, the preset arm bending angle, and the preset leg bending angle.

9. The industrial muscle-strength assistive robot of claim 8, wherein
the sensor part comprises:
a reference IMU sensor attached to the waist wearing member so as to be positioned on the waist of the user and configured to measure a reference inertial value;
a first IMU sensor attached to the upper body wearing member so as to be positioned on a back of the user and configured to measure a back inertial value;
a second IMU sensor attached to one of the pair of arm wearing members and configured to measure a first arm inertial value;
a third IMU sensor attached to other of the pair of arm wearing members and configured to measure a second arm inertial value;
a fourth IMU sensor attached to one of a pair of thighs of the user and configured to measure a first leg inertial value; and
a fifth IMU sensor attached to other of the pair of thighs of the user and configured to measure a second leg inertial value,
wherein the control part configured to compares the reference inertial value with the back inertial value to derive a waist bending angle of the user, and compares the reference inertial value with the first and second arm inertial values to derive an arm bending angle of the user, and compares the reference inertial value with the first and second leg inertial values to derive a leg bending angle of the user.
